(19) United States
(12) Patent Application Publication
(10) Pub. No.: US 2014/0281601 A1
(43) Pub. Date: Sep. 18, 2014

(54) POWER BOUNDARY CELL OPERATION IN MULTIPLE POWER DOMAIN INTEGRATED CIRCUITS

(71) Applicant: APPLE INC., Cupertino, CA (US)

(72) Inventors: Rakesh J. Patel, Sunnyvale, CA (US); Norman J. Rohrer, San Jose, CA (US)

(73) Assignee: Apple Inc., Cupertino, CA (US)

(21) Appl. No.: 13/826,695

(22) Filed: Mar. 14, 2013

(51) Int. Cl. G06F 1/32; G06F 1/26

(52) U.S. Cl. CPC G06F 1/32; G06F 1/263
USPC 713/320

(57) ABSTRACT

Embodiments of an apparatus are disclosed that may allow for the isolation of power domains. The apparatus may include a first power switch, a second power switch, and a boundary switch. The first power switch may be coupled between a global power supply and a first local power supply, and the second power switch may be coupled between the global power supply and a second local power supply. The first and second power switches may open in response to first and second power down signals respectively. The boundary switch may be coupled between the first local power supply and the second local power supply and may be configured to open in response to an isolation signal.

### BACKGROUND

1. Technical Field

This invention is related to the field of integrated circuit implementation, and more particularly to the implementation multiple power domains.

2. Description of the Related Art

Computing systems may include one or more systems-on-a-chip (SoC), which may integrate a number of different functions, such as, graphics processing, onto a single integrated circuit. With numerous functions included in a single integrated circuit, chip count may be kept low in mobile computing systems, such as tablets, for example, which may result in a smaller form factor for such mobile computing systems.

As semiconductor process technology has continued to evolve, device geometries continue to shrink, allowing a higher density of devices per unit area. With an increased density of devices, increased levels of integration may be possible, allowing for more functional blocks with increased complexity to integrated into a single SoC.

With higher levels of integration and higher performing devices, power consumption may be a limiting factor, particularly in mobile computing applications such as, e.g., tablets or cellular telephones. Different design techniques and architectures may be employed to limit leakage or dynamic power.

### SUMMARY OF THE EMBODIMENTS

Various embodiments of a memory circuit are disclosed. Broadly speaking, a circuit and a method are contemplated in which an apparatus includes a first power switch, a second power switch, and a boundary switch. The first and second power switches may be coupled between a global power supply and a first local power supply and a second local power supply, respectively. A first power down signal and a second power down signal may control the first power switch and the second power switch, respectively. The boundary switch may be coupled between the first local power supply and the second local power supply and may be configured to open in response to an isolation signal.

In another embodiment, the apparatus may include a control circuit. The control circuit may be configured to generate the isolation signal.

In a further embodiment, the control circuit may be configured to generate the second power down signal. The second power down signal may be generated in response to the activation of the isolation signal.

### BRIEF DESCRIPTION OF THE DRAWINGS

The following detailed description makes reference to the accompanying drawings, which are now briefly described.

FIG. 1 illustrates an embodiment of a system-on-a-chip.

FIG. 2 illustrates an embodiment of separate power domains with a system-on-a-chip.

FIG. 3 illustrates an embodiment of a power boundary switch coupled between two power domains.

FIG. 4 illustrates another embodiment of a power boundary switch coupled between two power domains.

FIG. 5 illustrates a flowchart of an example method of operating multiple power domains within a system-on-a-chip.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component. More generally, the recitation of any element is expressly intended not to invoke 35 U.S.C. §112, paragraph six interpretation for that element unless the language “means for” or “step for” is specifically recited.

### DETAILED DESCRIPTION OF EMBODIMENTS

To manage power within an SoC, one more clock domains may be employed. The use of multiple clock domains may allow for local clocks in various functional blocks or portions thereof, to be stopped, preventing the aforementioned blocks from consuming dynamic power during certain periods. While stopping a local clock to a functional block or sub-block may reduce dynamic power, the functional block or sub-block may still consume leakage power. In some embodiments, power switches may be employed to isolated a functional block or sub-block from a power supply. The use of such switches may result in lower leakage power for an unused functional block or sub-block.

Differences in the characteristics of power switches may result in variation between the voltage levels of local power supplies between different circuit blocks. In some cases, the variation in voltage levels between different circuit blocks may result in timing issues between signals that are transmitted between the different circuit blocks. The embodiments illustrated in the drawings and described below may provide techniques for the providing and operating multiple power domains within an integrated circuit while limiting timing issues involved with transmitting signals between the power domains.

### System-on-a-Chip Overview

A block diagram of an SoC is illustrated in FIG. 1. In the illustrated embodiment, the SoC 100 includes a processor 101 coupled to memory block 102, and analog/mixed-signal block 103, and I/O block 104 through internal bus 105. In various embodiments, SoC 100 may be configured for use in a mobile computing application such as, e.g., a tablet computer or cellular telephone. Transactions on internal bus 105 may be encoded according to one of various communication protocols. For example, transactions may be encoded using Peripheral Component Interconnect Express (PCIe), or any other suitable communication protocol.

Processor 101 may, in various embodiments, be representative of a general-purpose processor that performs computational operations. For example, processor 101 may be a central processing unit (CPU) such as a microprocessor, a microcontroller, an application-specific integrated circuit (ASIC), or a field-programmable gate array (FPGA). In some embodiments, processor 101 may include one or more register files and memories.

In some embodiments, processor 101 may implement any suitable instruction set architecture (ISA), such as, e.g., the ARM™, PowerPC™, or x86 ISAs, or combination thereof. Processor 101 may include one or more bus transceiver units that allow processor 101 to communication to other functional blocks within SoC 100 such as, memory block 102, for example.

Memory block 102 may include any suitable type of memory such as a Dynamic Random Access Memory (DRAM), a Static Random Access Memory (SRAM), a Read-only Memory (ROM), Electrically Erasable Programmable Read-only Memory (EEPROM), a FLASH memory, Phase Change Memory (PCM), or a Ferroelectric Random Access Memory (FeRAM), for example. In some embodiments, memory block 102 may be configured to store program code or program instructions that may be executed by processor 101. Memory block 102 may, in other embodiments, be configured to store data to be processed, such as graphics data, for example.

It is noted that in the embodiment of an SoC illustrated in FIG. 1, a single memory block is depicted. In other embodiments, any suitable number of memory blocks and memory types may be employed.

Analog/mixed-signal block 103 may include a variety of circuits including, for example, a crystal oscillator, a voltage reference, a current reference, a phase-locked loop (PLL) or delay-locked loop (DLL), an analog-to-digital converter (ADC), and a digital-to-analog converter (DAC) (all not shown). In other embodiments, analog/mixed-signal block 103 may be configured to perform power management tasks with the inclusion of on-chip power supplies, voltage regulators, and clock frequency scaling circuitry. Analog/mixed-signal block 103 may also include, in some embodiments, radio frequency (RF) circuits that may be configured for operation with cellular telephone networks.

I/O block 104 may be configured to coordinate data transfer between SoC 101 and one or more peripheral devices. Such peripheral devices may include, without limitation, storage devices (e.g., magnetic or optical media-based storage devices including hard drives, tape drives, CD drives, DVD drives, etc.), audio processing subsystems, graphics processing subsystems, or any other suitable type of peripheral devices. In some embodiments, I/O block 104 may be configured to implement a version of Universal Serial Bus (USB) protocol or IEEE 1394 (Firewire®) protocol, and may allow for program code and/or program instructions to be transferred from a peripheral storage device for execution by processor 101.

I/O block 104 may also be configured to coordinate data transfer between SoC 301 and one or more devices (e.g., other computer systems or SoCs) coupled to SoC 100 via a network. In one embodiment, I/O block 104 may be configured to perform the data processing necessary to implement an Ethernet (IEEE 802.3) networking standard such as Gigabit Ethernet or 10-Gigabit Ethernet, for example, although it is contemplated that any suitable networking standard may be implemented. In some embodiments, I/O block 104 may be configured to implement multiple discrete network interface ports.

Each of the functional blocks included in SoC 100 may be included in separate power and/or clock domains. In some embodiments, a functional block may be further divided into smaller power and/or clock domains. Each power and/or clock domain may, in some embodiments, be separately controlled thereby selectively deactivating (either by stopping a clock signal or disconnecting the power) individual functional blocks or portions thereof.

It is noted that the SoC illustrated in FIG. 1 is merely an example. In other embodiments, different functional blocks and different configurations of functions blocks may be possible dependent upon the specific application for which the SoC is intended.

### Power Domain Operation

Turning to FIG. 2, an embodiment of separate power domains with a system-on-a-chip is illustrated. The illustrated embodiment includes global power supply 201, power domain 202, and power domain 203. Power domain 202 includes switch device 204 and inverter 210, and power domain 203 includes switch device 205, flip-flop 211, and inverter 215.

Switch device 204 is controlled by control signal 206, and is coupled between global power supply 201 and local power supply 208. The power connection for inverter 210 is coupled to local power supply 208. Logic signal 214 is coupled to the input of inverter 210, whose output is coupled to logic signal 212. In some embodiments, switch device 204 may include one or more p-channel metal-oxide semiconductor field-effect transistors (MOSFETs), or any other suitable switching device.

Static complementary metal-oxide-semiconductor (CMOS) inverters, such as those shown and described herein, may be a particular embodiment of an inverting amplifier that may be employed in the circuits described herein. However, in other embodiments, any suitable configuration of inverting amplifier that is capable of inverting the logical sense of a signal may be used, including inverting amplifiers built using technology other than CMOS.

Switch device 205 is controlled by control signal 207, and is coupled between global power supply 201 and local power supply 209. The power connections for flip-flop 211 and inverter 215 (not shown) are coupled to local power supply 209. Logic signal 212 is coupled to the input of flip-flop 211 and the input of inverter 215. Flip-flop 211 is controlled by clock signal 213.

Flip-flops and latches, such as those shown and described herein may be designed according to one of various design styles. For example, latches and flip-flops may be implemented using either dynamic or static circuits, or a combination thereof. In some embodiments, each storage circuit may include scan cells as part of the implementation of a boundary scan test circuit.

During operation, control signals 206 and 207 may be set to a low logic level, thereby activating switch devices 204 and 205, respectively. The activation of switch devices 204 and 205 allow local power supplies 208 and 209 to charge to the voltage level of global power supply 201.

Variation in the on-resistances of switch devices 204 and 205 may result in different voltages on local power supplies 208 and 209. Such variation in the on-resistances of the switch devices may be the result of differences in lithography between the two devices, differences in dopant levels between the devices, and the like. Furthermore, differences in ballast or de-coupling capacitance between the two local power supplies can lead to further instantaneous variation in the voltage level between the two local power supplies as differing numbers of logic gates activate in the two power domains.

It is noted that “low” or “low logic level” refers to a voltage at or near ground and that “high” or “high logic level” refers to a voltage level sufficiently large to turn on a n-channel MOSFET and turn off a p-channel MOSFET. In other embodiments, different technology may result in different voltage levels for “low” and “high.”

Any difference between the voltage levels of local power supply 208 and local power supply 209 may result in failures when signals are transmitted from one power domain to the other. For example, when the voltage level of local power supply 208 is higher than the voltage level of local power supply 209, flip-flop 211 may operate too slowly relative to a change in logic levels on logic signal 212, resulting in a setup time failure.

It is noted that the memory illustrated in FIG. 2 is merely an example. In other embodiments, different numbers of power domains and different configurations of circuit elements with the power domains are possible.

FIG. 3 illustrates an embodiment of a power boundary switch coupled between two power domains. The illustrated embodiment includes global power supply 301, power domain 302, power domain 303, and boundary switch 308. Power domains 302 and 303 may, in some embodiments, correspond to different functional blocks within an SoC, such as, e.g., processor 101, memory 102, etc., as illustrated in FIG. 1. Power domain 302 includes switch device 304 and logic gates 309, and power domain switch device 305, inverter 311, and logic gates 310.

Switch device 304 is controlled by control signal 306 and is coupled between global supply 301 and local supply 314. Logic gates 309 are also coupled to local supply 314. Switch device 305 is controlled by control signal 307 and is coupled between global supply 301 and local supply 315. Logic gates 310 are also coupled to local power supply 311. Switch devices 304 and 305 may, in some embodiments, include one or more p-channel MOSFETs, or any other suitable switching device.

The power connection for inverter 311 is coupled to local power supply 315. Control signal 312 is coupled to the input of inverter 311, whose output is coupled to isolation signal 316. In other embodiments, inverter 311 may be located within power domain 302 and be coupled to local power supply 314.

Both logic gates 309 and 310 may include one or more circuit blocks, where each circuit block may include place-and-route blocks, full-custom logic or memory circuits, or any other suitable circuit. In some embodiments, logic gates 309 and 310 may include multiple supply wires (commonly referred to as “rails”) coupled to either the global power supply 301 or local power supplies 314 and 315.

Boundary switch 308 is controlled by isolation signal 316, and is coupled between local power supply 314 and local power supply 315. Boundary switch 308 may include one or more p-channel MOSFETs whose bulk terminals are coupled to local power supply 315, while in other embodiments, the bulk terminals may be coupled to local power supply 314. In some embodiments, boundary switch 308 may be implemented as a transmission gate. Multiple boundary switches may be employed, coupling each rail of local power supply 314 to a corresponding rail of local power supply 315.

It is noted that a transmission gate may include an n-channel metal-oxide-semiconductor field-effect transistor (MOSFET) and a p-channel MOSFET connected in parallel. In other embodiments, a single n-channel MOSFET or a single p-channel MOSFET may be used as a pass gate. It is further noted that, in various embodiments, a “transistor” may correspond to one or more transconductance elements such as a junction field-effect transistor (JFET), for example.

During operation, control signals 306 and 307 may both be at a low logic level, activating, i.e., closing, switch devices 304 and 305, respectively. With switch devices 304 and 305 active, local power supplies 314 and 315 are both coupled to global power supply 301, providing power to logic gates 309 and logic gates 310. Control signal 312 may be at a high logic level, which may be converted to a low logic level on isolation signal 316 by inverter 311. The low logic level on isolation signal 316 may activate boundary switch 308, thereby coupling local power supply 314 to local power supply 315. In some embodiments, coupling local power supply 314 to local power supply 315 may reduce differences in the voltage level between the local power supplies and reduce errors, such as, e.g., hold time failures, when transmitting signals from one power domain to the other.

In some embodiments, a request to power down power domain 302 may be detected. The request may be the result of a processing unit executing programming instructions, or the result of stimulus external to the integrated circuit or SoC on which power domains 302 and 303 reside. In response to the detected power down request, control signal 312 may be set to a low logic level, which inverter 311 converts to a high logic level on isolation signal 316.

The high logic level on isolation signal 316 may de-activate, i.e., open, boundary switch 308, thereby de-coupling local power supply 314 from local power supply 315. Once the two local power supplies have been de-coupled, control signal 306 may set to a high logic level, de-activating switch device 304. Once switch device 304 is de-activated, there is not longer a path from global power supply 301 to logic gates 309. In some embodiments, the lack of a connection to global power supply 301 may result in reduced power consumption for power domain 302.

In some embodiments, a request to restore power to power domain 302 may be detected. In such cases, control signal 306 may be set a low logic level, re-activating switch device 304, thereby providing power to logic gates 309, allowing them to operate. Once switch device 304 has been re-activated, control signal 312 may be set to a high logic level, which may be inverted to a low logic on isolation signal 316 my inverter 311. The low logic level on isolation signal 316 may then re-activate, i.e., close, boundary switch 308, thereby coupling local power supply 314 to local power supply 315.

It is noted that the power domains illustrated in FIG. 3 is merely an example. In other embodiments, different power domains and different numbers of power domains may be employed.

Another embodiment of a power boundary switch coupled between two power domains is illustrated in FIG. 4. In some embodiments, the two power domains, 402 and 403, may correspond to different functional blocks of an SoC such as, e.g., processor 101 and memory 102 of SoC 100 as illustrated in FIG. 1. The embodiment illustrated in FIG. 4 includes global power supply 401, global ground 417, power domain 402, and power domain 403. Power domain 402 includes logic gates 404 and switch device 410, and power domain 403 includes logic gates 405, inverter 415, and power switch 411.

Logic gates 404 are coupled to global power supply 401 and local power supply 406. Local power supply 406 is further coupled to switch device 410, which is controlled by control signal 412. Switch device 410 is further coupled to global ground 417. In some embodiments, switch device 410 may include one or more n-channel MOSFETs, or any other suitable switching device.

Logic gates 405 are coupled to global power supply 401 and local power supply 407. Local power supply 407 is further coupled to switch device 411, which is controlled by control signal 413, and provides the ground reference to inverter 415. Switch device 411 is further coupled to global ground 417. In some embodiments, switch device 411 may include one or more n-channel MOSFETs, or any other suitable switching device.

Control signal 416 is coupled to the input of inverter 415, whose output is coupled to isolation signal 409. The ground connection for inverter 415 is coupled to local power supply 407, and the power connection for inverter 415 is coupled to global power supply 401 (not shown). In some embodiments, the ground connection for inverter 415 may be coupled to global ground 417. In other embodiments, inverter 415 may be located within power domain 402.

Both logic gates 404 and 405 may include one or more circuit blocks, and each circuit block may include place-and-route logic blocks, full-custom logic or memory circuits, or any other suitable circuit. In some embodiments, logic gates 404 and 405 may include multiple supply wires (commonly referred to as “rails”) coupled to either global power supply 401 or local power supplies 406 and 407, respectively.

Boundary switch 408 is controlled by isolation signal 409, and is coupled between local power supply 406 and local power supply 407. In some embodiments, boundary switch 408 may be an n-channel MOSFET whose bulk connection is coupled to global ground 417, or any other suitable switching device. Boundary switch 408 may, in some embodiments, be implemented as a transmission gate. Multiple boundary switches may be employed coupling each rail of local power supply 406 to a corresponding rail of local power supply 407.

During normal operation, control signals 412 and 413 are both at a high logic level, activating switch devices 410 and 411, respectively. With switch devices 410 and 411 both active, local power supplies 406 and 407 are both coupled to global ground 417, providing a path to ground for logic gates 404 and 405. Control signal 416 may be at a low logic level, which may be converted to a high logic level on isolation signal 409 by inverter 415. The high logic level on isolation signal 409 activates boundary switch 408, coupling local power supply 406 to local power supply 407. In some embodiments, coupling local power supply 406 to local power supply 407 may reduce differences in the voltage level between the local power supplies and facilitate accurate transmission of data from one power domain to the other.

In some embodiments, a request to power down power domain 404 may be detected. The request may be the result of a processing unit executing programming instructions, or the result of stimulus external to the integrated circuit or SoC on which power domains 402 and 403 reside. In response to the detected power down request, control signal 416 may be set to an high logic level, resulting, through inverter 415, in a low logic level on isolation signal 409.

The low logic level on isolation signal 409 may de-activate, i.e., open, boundary switch 408, thereby de-coupling local power supply 406 from local power supply 407. Once the two local power supplies have been de-coupled, control signal 412 may be set to a low logic level, de-activating switch device 410. Once switch device 410 has been de-activated, there is no longer a path to ground for logic gates 404. In some embodiments, the lack of a path to ground for logic gates 404 may result in a reduction in power consumption for logic gates 404.

In some embodiments, a request to restore power to power domain 404 may be detected. In such cases, control signal 412 may be set to a high logic level, re-activating switch device 410, returning the path to ground for logic gates 404, and allowing logic gates 404 to operate. Once the switch device 410 has been re-activated, control signal 416 may be set to a low logic level, which is inverted to a high logic level on isolation signal 409 by inverter 415. The high logic level on isolation signal 409 may then re-activate, i.e., close, boundary switch 408, thereby coupling local power supply 406 to local power supply 407.

It is noted that the embodiment illustrated in FIG. 4 is merely an example. In other embodiments, different numbers of power domains, and different numbers of boundary switches are possible and contemplated.

Turning to FIG. 5, a flowchart depicting a method for operating power boundary switches such as, e.g., power boundary switch 308 as illustrated in FIG. 3. Referring collectively to FIG. 3 and the flowchart illustrated in FIG. 5, the method begins in block 501.

A detection of a power down condition may then be made (block 502). During operation of an SoC, such as SoC 100 as illustrated in FIG. 1, a determination may be made to power down one or more functional blocks (or portions thereof), such as memory block 102. The determination may be made by processor 101 in response to execution of programming instructions retrieved from memory. In some embodiments, the determination may be made in response to an external stimulus such as, e.g., activation of a sleep or power down button on a mobile computing device.

Once such a determination has been made, supply rails between the functional blocks or sub-blocks that are to be powered down and adjacent blocks may be isolated (block 503). For example, it may be determined that block 302 is to be powered down. In response to that determination, boundary switch 308 may be opened, isolating local supplies 314 and 315. In some embodiments, setting isolation signal 310 to a high logic level may open boundary switch 308.

With the power supply rails for local power supplies 314 and 315, isolated from each other, the power switch for block 302 may be opened (block 504). In some embodiments, control signal 306 may be set to a high logic level, deactivating switch device 304, thereby de-coupling local supply 314 from global power supply 301. De-coupling local supply 314 from global power supply 301 may, in some embodiments, reduce leakage power consumed by logic gates 309 in block 302.

With block 302 in a powered down state, a request to restored power to the block may be detected (block 505). In some embodiments, another block such as, e.g., block 303, or a processor, such as processor 101 as illustrated in FIG. 1, for example, may receive the request to restore power to block 302. The request may be in the form of one or more programming instructions stored in a memory. In other embodiments, the request may be from external source, such as, e.g., a power-on switch on a mobile computing device.

In response to the detection of the request to restore power to the block 302, the power switch for block 302 may be closed (block 506). In some embodiments, control signal 306 may be set to a low logic level, activating switch device 304, thereby coupling local supply 314 to global power supply 301.

As the voltage level on local power supply 314 reaches the level of global power supply 301, the power rails of local power supply 314 may be coupled to power supply rails of local power supplies of adjacent blocks, such as, e.g., block 303 (block 507). In some embodiments, control signal 316 may be set to a logic low level, thereby activating boundary switch 308, coupled local power supply 314 to local power supply 315. Coupling local power supply 314 to local power supply 315 may, in some embodiments, reduce differences between the voltage levels of the two local supplies, thereby improving signal transfer between block 302 and 303. Once local power supply 314 and local power supply 315 have been coupled together, the method concludes in block 508.

In some embodiments, operating power boundary switches employing the method depicted in the flowchart of FIG. 5, may result in lower power-ground noise. A design may, in other embodiments, be operated at higher performance (e.g., higher clock frequencies) or at lower power supply pin voltages by employing such power boundary switch operating methods. It is noted that the operations illustrated in FIG. 5 as depicted as being performed in a sequential fashion. In other embodiments, one or more of the illustrated operations may be performed in parallel.

Numerous variations and modifications will become apparent to those skilled in the art once the above disclosure is fully appreciated. It is intended that the following claims be interpreted to embrace all such variations and modifications.

What is claimed is:

1. An apparatus, comprising:
a first power switch coupled between a global power supply and a first local power supply, wherein the first power switch is configured to be set in an open position in response to the assertion of a first power down signal, and be set in a closed position in response to the de-assertion of the first power down signal;
a second power switch coupled between the global power supply and a second local power supply, wherein the second power switch is configured to be set in an open position in response to the assertion of a second power down signal, and set in a closed position in response to the de-assertion of the second power down signal;
a boundary switch coupled between the first local power supply and the second local power supply, wherein the boundary switch is configured to be set in an open position in response to the assertion of an isolation signal; and
a control circuit configured to generated the first power down signal, the second power down signal, and the isolation signal.

2. The apparatus of claim 1, wherein the control circuit is coupled to the first local power supply.

3. The apparatus of claim 2, wherein the control circuit is further configured to generate the second power down signal in response to the activation of the isolation signal.

4. The apparatus of claim 2, wherein the boundary switch comprises one or more re-channel metal-oxide semiconductor field-effect transistors (MOSFETs).

5. The apparatus of claim 1, wherein the global power supply is a positive power supply.

6. The apparatus of claim 1, further comprising a first circuit block coupled to the first local power supply and a second circuit block coupled to the second local power supply.

7. The apparatus of claim 1, wherein the boundary switch comprises one or more p-channel metal-oxide semiconductor field-effect transistors (MOSFETs).

8. A method, comprising:
detecting a request to power down a first power domain of an integrated circuit;
isolating the first power domain from a second power domain of the integrated circuit;
isolating the first power domain from a global power supply of the integrated circuit;
detecting a request to power up the first power domain of the integrated circuit;
coupling the first power domain to the global power supply of the integrated circuit; and
coupling the first power domain of the integrated circuit to the second power domain of the integrated circuit.

9. The method of claim 8, wherein the first power domain includes a first plurality of circuit sub-blocks.

10. The method of claim 9, wherein the second power domain includes a second plurality of circuit sub-blocks.

11. The method of claim 8, wherein isolating the first power domain from the second power domain comprises opening one or more power boundary switches, wherein the one or more power boundary switches are coupled between a respective one or more internal power supply lines of the first power domain and a respective one or more internal power supply lines of the second power domain.

12. The method of claim 11, wherein isolating the first power domain from the global power supply comprises opening one or more switches between the global power supply and one or more internal power supply lines of the first power domain.

13. The method of claim 12, wherein each of the one or more switches comprises a metal-oxide semiconductor field-effect transistor (MOSFET).

14. The method of claim 12, wherein the global power supply is a ground supply.

15. A system, comprising:
a first functional block including a first power switch, wherein the first power switch is coupled between a global power supply and a first local power supply;
a second functional block including a second power switch, wherein the second power switch is coupled between the global power supply and a second local power supply;
a boundary switch coupled between the first local power supply and the second local power supply, wherein the boundary switch is configured to open responsive to an isolation signal; and
a processor configured to generate the isolation signal.

16. The system of claim 15, wherein the processor is further configured to generated the isolation signal responsive to the execution of one or more programming instructions.

17. The system of claim 15, wherein the first power switch is configured to open responsive to a first control signal.

18. The system of claim 17, wherein the processor is further configured to generate the first control signal.

19. The system of claim 18, wherein the processor is further configured to generate the first control signal responsive to the isolation signal.

20. The system of claim 19, wherein the processor is coupled to the second local power supply.
